(19) United States
(12) Patent Application Publication
(10) Pub. No.: US 2025/0077234 A1
(43) Pub. Date: Mar. 6, 2025

(54) EXECUTION METHOD FOR INSTRUCTION CONFLICT, INSTRUCTION PROCESSING MODULE AND PROCESSOR

(71) Applicant: GLENFLY TECH CO., LTD. (SHANGHAI), Shanghai (CN)

(72) Inventors: Renyu BIAN, Shanghai (CN); Huaisheng ZHANG, Shanghai (CN); Yuqin YU, Shanghai (CN)

(73) Assignee: GLENFLY TECH CO., LTD. (SHANGHAI), Shanghai (CN)

(21) Appl. No.: 18/819,125

(22) Filed: Aug. 29, 2024

(30) Foreign Application Priority Data
Aug. 29, 2023 (CN) 202311106948.0

(51) Int. Cl. G06F 9/38; G06F 9/30

(52) U.S. Cl. CPC G06F 9/3836; G06F 9/30189

(57) ABSTRACT

An execution method for instruction conflict, includes: obtaining instructions to be executed in waves; determining whether a first instruction of a first wave meets one or more instruction emission conditions; determining, based on the first instruction meeting the one or more instruction emission conditions, a type of the of the first instruction; issuing, based on the type being a second type, the first instruction to be executed; and executing an operation of the first instruction.

### CROSS-REFERENCE TO RELATED APPLICATION

This application claims priority from Chinese Patent Application No. 202311106948.0, filed with the China National Intellectual Property Administration on Aug. 29, 2023, the contents of which is incorporated herein by reference in its entirety.

### FIELD

The disclosure relates to graphic data processing; and more particularly, to execution method for instruction conflict, instruction processing module and processor.

### BACKGROUND

In processors such as central processing units (CPUs), the instruction execution unit (IEU) is the most core module in the processor, and the accurate and effective execution of instructions is crucial. On rendering platforms such as D3D, OpenGL, and Vulkan, various programmable shaders are the important parts of graphic rendering. These shaders include vertex shader (VS), pixel shader (PS), hull shader (HS), and domain shader (DS). These shaders may be converted by the compiler into a large number of hardware instructions that processor will process, including basic arithmetic logic (AL) instructions, special function (SF) instructions, texture sampling (Sample) instructions, and memory load store (LS) instructions, for example.

Graphics processing units (GPUs) may have a specially defined set of instructions, such as NVIDIA's PTX and AMD's ISA, and the correct execution of instructions is also crucial.

When processors encounter instructions with long or variable instruction execution times, the compiler may set a wait-flag on these instructions. Before the subsequent instruction reads or writes its register, a check instruction may be generated. A wave control module (WVC) may be responsible for scheduling the instructions of each wave to be issued in an orderly manner to the IEU. For example, the WVC may send the wait-flag along with the instructions to the instruction execution unit. The IEU receives the wait-flag. After the instruction is executed, the IEU may send the wait-flag back to WVC. When encountering a check instruction, WVC may receive the wait-flag that was previously sent before it can send the instruction after executing the check instruction, to ensure the order in which instructions read and write registers within the wave.

However, this method may require the cooperation of the compiler, may require setting wait-flags on instructions with longer execution times, and may require generating a check instruction before the instruction that experienced conflicts in accessing registers. As a result, the complexity of the compiler's work may be increased; accurately locating the source of check instructions may be difficult; check instructions may be generated in advance, which may result in instructions without register-accessing conflicts being unable to be sent immediately, thus introducing waiting clock cycles and reducing the execution efficiency of instructions; because each check instruction requires at least one execution clock cycle, the total execution time of instructions of each wave is increased.

### SUMMARY

Provided are an execution method for instruction conflict, an apparatus, and a non-transitory computer-readable storage medium.

According to some embodiments, an execution method for instruction conflict, includes: obtaining a plurality of instructions to be executed in a plurality of waves; determining whether a first instruction of a first wave meets one or more instruction emission conditions; determining, based on the first instruction meeting the one or more instruction emission conditions, a type of the of the first instruction; issuing, based on the type being a second type, the first instruction to be executed; and executing an operation of the first instruction.

According to some embodiments, a processor for handling instruction conflict, may be configured to execute processing instructions, the processing instructions including: obtaining instructions configured to cause the processor to obtain a plurality of instructions to be executed in a plurality of waves; first determining instructions configured to cause the processor to determine whether a first instruction of a first wave meets one or more instruction emission conditions; second determining instructions configured to cause the processor to determine, based on the first instruction meeting the one or more instruction emission conditions, a type of the of the first instruction; issuing instructions configured to cause the processor to issue, based on the type being a second type, the first instruction to be executed; and executing instructions configured to cause the processor to execute an operation of the first instruction.

According to some embodiments, a non-transitory computer-readable storage medium, storing computer code which, when executed by at least one processor, causes the at least one processor to at least: obtain a plurality of instructions to be executed in a plurality of waves; determine whether a first instruction of a first wave meets one or more instruction emission conditions; determine, based on the first instruction meeting the one or more instruction emission conditions, a type of the of the first instruction; issue, based on the type being a second type, the first instruction to be executed; and execute an operation of the first instruction.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a structural schematic diagram of the instruction processing module according to some embodiments;

FIG. 2 is a state table of recording the dependency flags dep_flag corresponding to the common registers according to some embodiments in the dependency flag unit;

FIG. 3 is a schematic diagram of setting and cleaning the dependency flags corresponding to the common registers according to some embodiments;

FIG. 4 is flowchart of the execution method for instruction conflict according to some embodiments;

FIG. 5 is a flowchart of operation 200 of the execution method for instruction conflict according to some embodiments;

FIG. 6 is a flowchart of operation 900 of the execution method for instruction conflict according to some embodiments;

FIG. 7 is a comparison schematic diagram of instruction execution.

### DETAILED DESCRIPTION

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure and the appended claims.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may comprise all possible combinations of the items enumerated together in a corresponding one of the phrases. For example, the phrase “at least one of A, B, and C” comprises within its scope “only A”, “only B”, “only C”, “A and B”, “B and C”, “A and C” and “all of A, B, and C.”

In processors such as CPUs or GPUs, for example, the execution clock cycles for instructions of different types may not be equal and may be uncertain. Consequently, the read-write ordering to the same registers through instructions of different types from the same wave may not be ensured, resulting in errors in the read and write contents of the register. Therefore, an execution method for instruction conflicts, an instruction processing module, and a processor are disclosed, and by setting a dependency flag, dep_flag, for each register, a 1-bit flag is used for each register to indicate whether there is a dependency with previous instructions, where 0 means no dependency and 1 means a dependency. Whenever an instruction executed its execution time is uncertain and long, set the register's dep_flag read and written by this instruction to 1. After the register is read and written, reset the corresponding register's dep_flag to 0. Before executing each instruction, it checks whether all registers' dep_flags read and written by this instruction are 0 or not, the instruction can be executed if all are 0, otherwise, the instruction can be executed after the dep_flag is reset to 0. This may resolve read and write conflicts for when instructions within waves access registers, while also avoiding additional processing by the compiler.

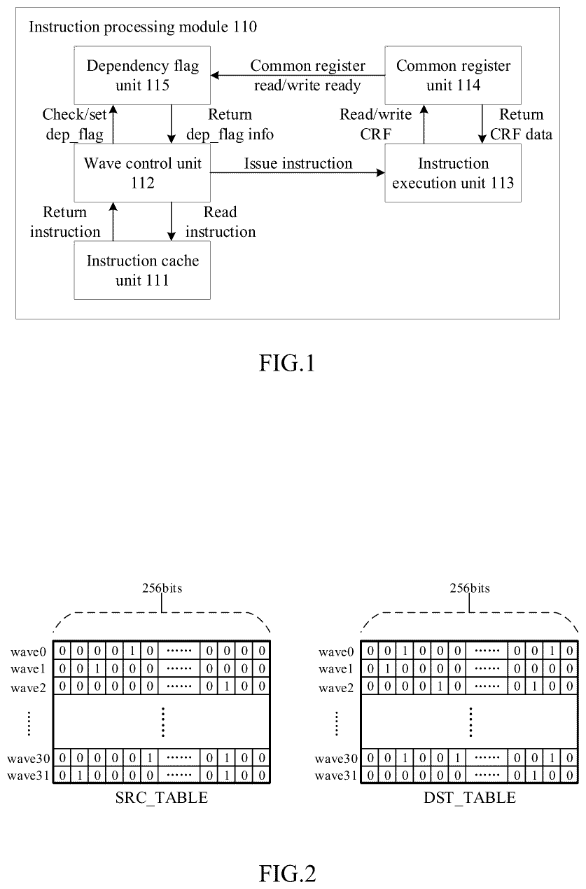

A processor according to some embodiments provides an instruction processing module 110. As shown in FIG. 1, the instruction processing module 110 comprises an instruction cache unit 111, a wave control unit 112, an instruction execution unit 113, a common register unit 114, and a dependency flag unit 115. The instruction cache unit 111 is connected to the wave control unit 112. The wave control unit 112 is connected to the dependency flag unit 115 and the instruction execution unit 113, respectively. The dependency flag unit 115 and the instruction execution unit 113 are connected to the common register unit 114, respectively.

The instruction cache unit 111 is used to store instructions for each wave read from memory, and to fetch instructions in response to the fetch instruction request signal and issue them to the wave control unit 112, wherein the fetch instruction request signal is sent from the wave control unit 112 to instruction cache unit 111.

The wave control unit 112 is used to manage the execution of instructions for multiple waves, obtain multiple instructions that each wave is to execute from the instruction cache unit 111, check the instruction emission conditions of each instruction and issue the instruction to the instruction execution unit 113 when the instruction emission conditions are met, and determine whether to send a setting signal to the dependency flag unit 115 based on the current type of instruction. When the instruction is executed by the wave control unit 112, before the wave control unit 112 prepares to issue the instruction to the instruction execution unit 113, the wave control unit 112 checks whether the instruction meets the instruction emission conditions, wherein the instruction transmission conditions include whether the common register that the current instruction is to read and write is ready, or whether the instruction execution unit 113 can accept the current instruction. Since the processing of instructions may be relatively complex, the clock cycles required may be longer, and such instructions may not be accepted every clock cycle. Therefore, before the wave control unit 112 issues instructions, such instructions may be checked to evaluate with the instructions may be issued to the instruction execution unit 113. The wave control unit 112 ensures the order of instruction access to common registers by checking the dependency flags in dependency flag unit 115. Since the various types of instructions, such as sample instructions, load/store instructions related to memory, instructions with longer and uncertain execution times, and ordinary ALU (arithmetic logic unit) instructions, in these instructions, sampling instructions, read/store instructions, or instructions with longer and uncertain execution times may update dependency flags during execution, while ordinary ALU instructions may not update dependency flags.

The instruction execution unit 113 is used to receive instructions issued by the wave control unit 112, read operands from the common register unit 114 according to the instructions, then execute operations of the instructions, and write the obtained execution results back to the common register unit 114.

The dependency flag unit 115 is used to store the dependency flag of each common register. When receiving a setting signal from the wave control unit 112, the value of the dependency flag corresponding to the common register accessed by the current instruction is set to 1. When receiving a read-write preparation signal from the common register unit 114, the value of the dependency flag corresponding to the common register accessed by the current instruction is set to 0. When receiving a check signal from the wave control unit 112, the value of the dependency flag corresponding to the current instruction is checked, and the check result is returned to the wave control unit 112.

As shown in FIG. 2, the dependency flag unit 115 has a source state table (SRC_TABLE) for storing the first source dependency flag of the source register and a second source dependency flag of the destination register, as well as a destination state table (DST_TABLE) for storing the first destination dependency flag of the source register and the second destination dependency flag of the destination register. In the source state table and the destination state table, each table has 32 rows, each row has 256 bits, used to record the dependency flags dep_flag corresponding to the source register (source CRF) or destination register (destination CRF) of 32 waves (wave), where the number of waves is 32, which is just one instance and not limited to this number. At the same time, 256 bits correspond to 256 common registers, where every 1 bit represents the dependency flag dep_flag corresponding to one common register, and the number of common registers is not limited to 256. When receiving the setting signal sent by the wave control unit 112, the dependency flag unit 115 sets the first source dependency flag corresponding to the source register accessed by the current instruction in the source state table, the first destination dependency flag corresponding to the source register accessed by the current instruction in the destination state table, the second source dependency flag corresponding to the destination register accessed by the current instruction in the source state table, and the second destination dependency flag corresponding to the destination register accessed by the current instruction in the destination state table to 1. When receiving the read-write preparation signal sent by the common register unit 114, the dependency flag unit 115 cleans the first source dependency flag and the second source dependency flag in the source state table corresponding to the current read register corresponding to the current instruction of in the common register unit 114. When receiving the execution result data sent by the common register unit 114, the dependency flag unit 115 cleans the first destination dependency flag and the second destination dependency flag in the destination state table corresponding to the current written register corresponding to the current instruction in the common register unit 114. When receiving a check signal from the wave control unit 112, the dependency flag unit 115 first checks whether the first destination dependency flag corresponding to the source register accessed by the current instruction in the destination state table is all 0. If all are 0, it then checks whether the second source dependency flag and second destination dependency flag corresponding to the destination register accessed by the current instruction in the source state table and destination state table are all 0.

The common register unit 114 is used to store the source operands and the destination operands of instructions. Each instruction processing module 110 has one common register unit 114. Each common register unit 114 consists of n (n can be taken as 256, 512, etc.) common registers. Each common register can store one source operand or one destination operand of instructions. The R0, R1 . . . . R255 mentioned later respectively represent the first, the second . . . the 255^{th} common register.

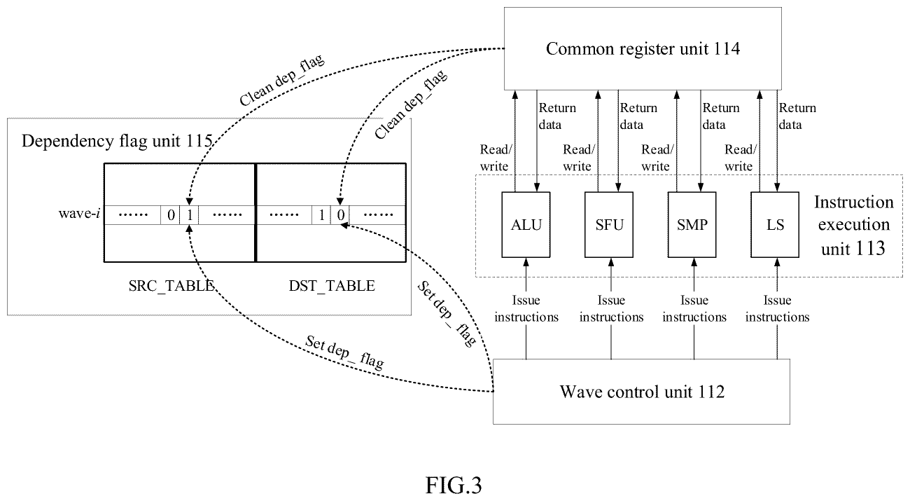

The instruction processing module 110 solves the problem of the execution conflicts between instructions by setting the dependency flag dep_flag for the general registers accessed by the instructions through the aforementioned units. The wave control unit 112 sets the dependency flag dep_flag corresponding to the common registers used by the instructions to 1 (including the first source dependency flag and the first destination dependency flag of the source register, the second source dependency flag and the second destination dependency flag of the destination register) before preparing to send them to the instruction execution unit 113 for instructions with long or uncertain execution clock cycles. After the instruction execution unit 113 reads the source operands of the common registers, its corresponding first source dependency flag and second source dependency flag in the source state table are set to 0. And after the instruction execution unit 113 finishes executing the instruction, the first destination dependency flag and the second destination dependency flag corresponding to this set of common registers in the destination state table are set to 0. Before issuing any instruction to the instruction execution unit 113, the wave control unit 112 may check the dependency flag dep_flag corresponding to the common registers accessed by the current instruction. When the dependency flags dep_flag corresponding to these common registers are all 0, for example, the values of the first source dependency flag, the first destination dependency flag, the second source dependency flag, and the second destination dependency flag are all 0, can the current instruction be issued to instruction execution unit 113; otherwise, the current instruction may not be issued to instruction execution unit 113 until the value of the dependency flag dep_flag becomes 0. As shown in FIG. 3, the instruction execution unit 113 has four subunits, for example, ALU (arithmetic logic unit), SFU (special function unit), SMP (sample unit), and LS (load/store unit). The ALU unit is responsible for processing AL (arithmetic logic) instructions. The SFU unit is responsible for processing SF (special function) instructions. The SMP unit is responsible for processing sampling instructions. And the LS unit is responsible for processing read/store instructions related to memory. The wave control unit 112 may issue different types of instructions to the corresponding subunits in instruction execution unit 113, but the latency for processing instructions varies among different subunits. So when different instructions are executed, the timing of read and write common registers also varies, resulting in register read and write conflicts.

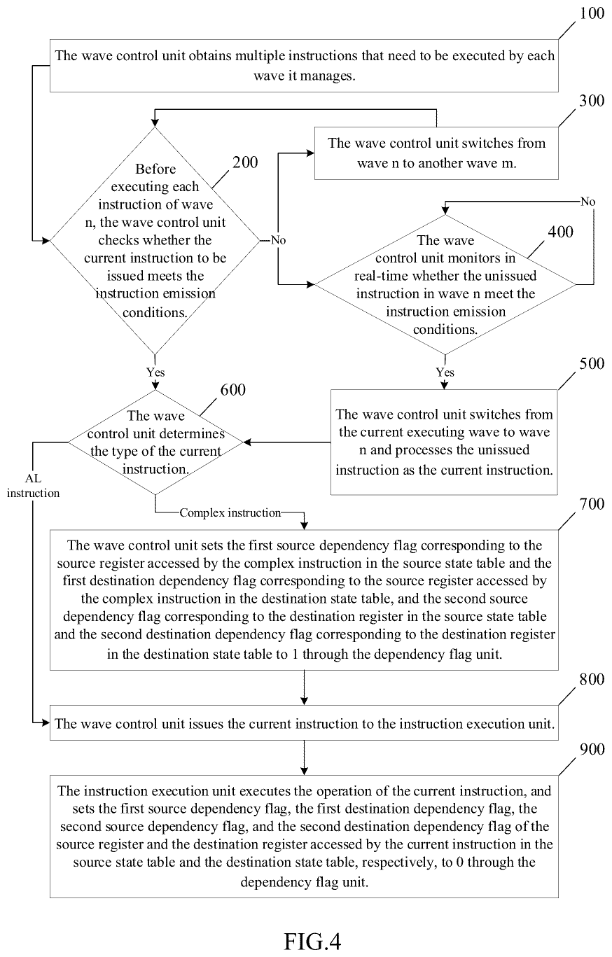

The following will describe the execution method for instruction conflict executed by the instruction processing module 110 according to some embodiments. Referring to FIG. 4, this execution method comprises:
Operation 100: The wave control unit 112 obtains multiple instructions that to be executed by each wave it manages;
Operation 200: Before executing each instruction of wave n, the wave control unit 112 checks whether the current instruction to be issued meets the instruction emission conditions; if it does not meet the requirements, execute operation 300 and operation 400 simultaneously; if it meets the requirements, execute operation 600;
Operation 300: The wave control unit 112 switches from wave n to another wave m and returns to execute operation 200;
Operation 400: The wave control unit 112 monitors in real-time whether the unissued instruction in wave n meet the instruction emission conditions; if it does not meet the requirements, return to execute operation 400 repeatedly; if it meets the requirements, execute operation 500;
Operation 500: The wave control unit 112 switches from the current executing wave to wave n and processes the unissued instruction as the current instruction;
Operation 600: The wave control unit 112 determines the type of the current instruction; if the current instruction is a complex instruction, execute operation 700; if the current instruction is an arithmetic logic instruction, execute operation 800;
Operation 700: The wave control unit 112 sets the first source dependency flag corresponding to the source register accessed by the complex instruction in the source state table and the first destination dependency flag corresponding to the source register accessed by the complex instruction in the destination state table, and the second source dependency flag corresponding to the destination register in the source state table and the second destination dependency flag corresponding to the destination register in the destination state table to 1 through the dependency flag unit 115;
Operation 800: The wave control unit 112 issues the current instruction to the instruction execution unit 113;
Operation 900: The instruction execution unit 113 executes the operation of the current instruction, and sets the first source dependency flag, the first destination dependency flag, the second source dependency flag, and the second destination dependency flag of the source register and the destination register accessed by the current instruction in the source state table and the destination state table, respectively, to 0 through the dependency flag unit 115;
where n and m are natural numbers.

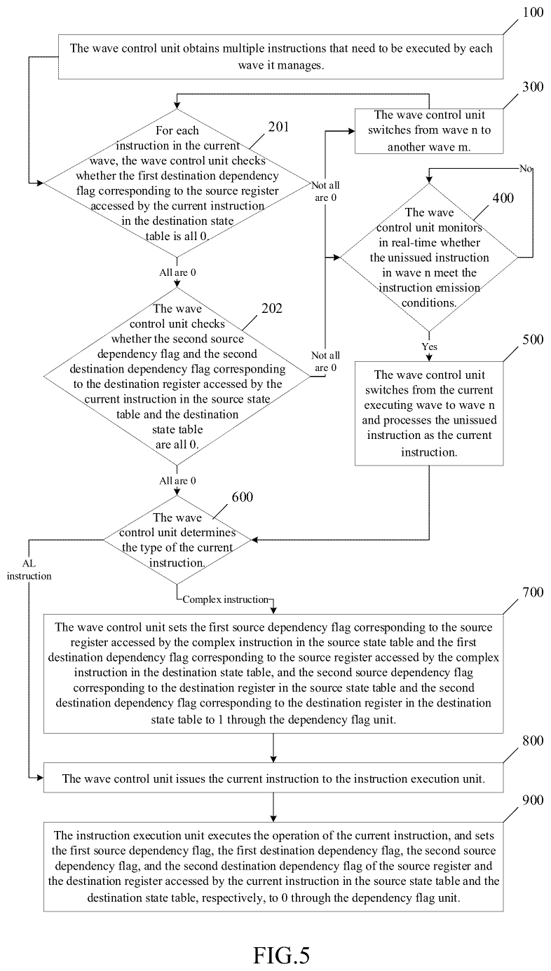

Referring to FIG. 5, in some embodiments, the process of determining the instruction emission conditions described in operation 200 may include:
Operation 201: For each instruction in the current wave, the wave control unit 112 checks whether the first destination dependency flag corresponding to the source register accessed by the current instruction in the destination state table is all 0; if all are 0, execute operation 202; if not all are 0, execute operation 300 and operation 400 simultaneously;
Operation 202: The wave control unit 112 checks whether the second source dependency flag and the second destination dependency flag corresponding to the destination register accessed by the current instruction in the source state table and the destination state table are all 0; if all are 0, execute operation 600; if not all are 0, execute operation 300 and operation 400 simultaneously.

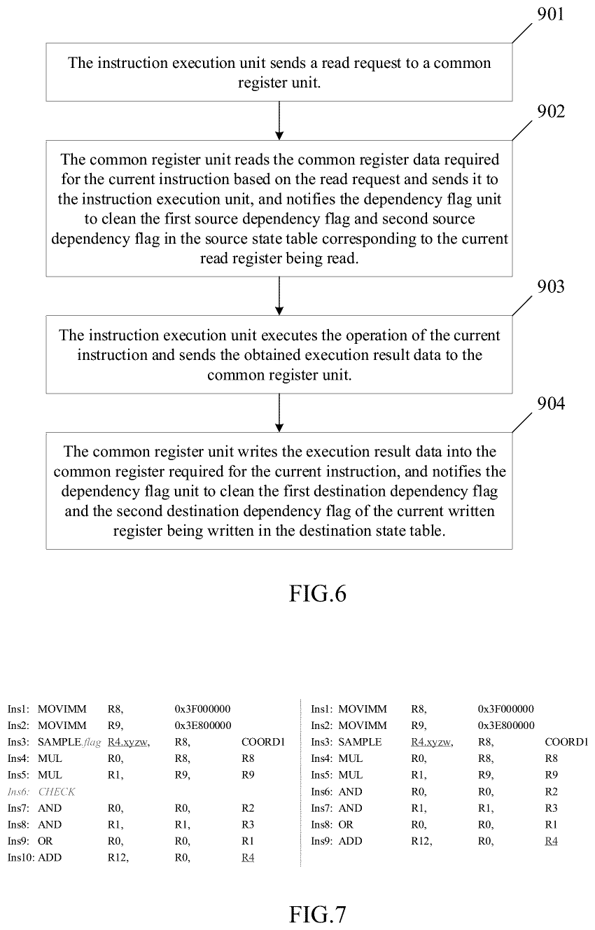

Referring to FIG. 6, in some embodiments, operation 900 may include:
Operation 901: The instruction execution unit 113 sends a read request to a common register unit 114;
Operation 902: The common register unit 114 reads the common register data required for the current instruction based on the read request and sends it to the instruction execution unit 113, and notifies the dependency flag unit 115 to clean the first source dependency flag and second source dependency flag in the source state table corresponding to the current read register being read;
Operation 903: The instruction execution unit 113 executes the operation of the current instruction and sends the obtained execution result data to the common register unit 114;
Operation 904: The common register unit 114 writes the execution result data into the common register required for the current instruction, and notifies the dependency flag unit 115 to clean the first destination dependency flag and the second destination dependency flag of the current written register being written in the destination state table.

The wave control unit 112 receives an instruction from the instruction cache unit 111, and after decoding the instruction, it checks whether the first destination dependency flag corresponding to the source register of the current instruction in the destination state table is all 0? If all are 0, jump to operation 202. If not all are 0, the wave control unit 112 can switch to another wave m, and then cannot switch back to the current wave n until all the first destination dependency flags to be checked by the instruction of the current wave n are all 0. Recheck whether the second source dependency flag and the second destination dependency flag corresponding to the destination register of the current instruction in the source state table and the destination state table are all 0? If all are 0, jump to operation 600. If not all are 0, the wave control unit 112 can switch to another wave m, and then cannot switch back to the current wave n until all the second source dependency flags and second destination dependency flags to be checked by the current wave n instruction are all 0. The current instructions include arithmetic logic instructions (AL instructions) and complex instructions. AL instructions are operation instructions that may not require updating dependency flags, while complex instructions include instructions related to sample, load/store, memory, and instructions with long and uncertain execution times that require updating dependency flags. When determining that the current instruction is an AL instruction, the dependency flag may not be updated in the source state table and the destination state table, and skip to operation 800. When determining that the current instruction is a complex instruction, the dependency flag may be updated in the source state table and the destination state table, execute operation 700, and then execute operation 800. After the wave control unit 112 obtains that the common register required for the current instruction is not occupied and the current instruction can be issued to the instruction execution unit 113, the wave control unit 112 sets the first source dependency flag, the second source dependency flag, the first destination dependency flag, and the second destination dependency flag corresponding to the source register and the destination register of the current instruction in the source state table and the destination state table to 1, and then issues the current instruction to the instruction execution unit 113. The instruction execution unit 113 sends a read request to the common register unit 114. After the common register receives the read request and sends the CRF data to the instruction execution unit 113, the common register unit 114 notifies the dependency flag unit 115 to clean the first source dependency flag and the second source dependency flag in the source state table of the current read register being read. The instruction execution unit 113 receives the CRF data returned by the common register unit 114, and after executing the operation of the instruction, it sends the execution result data to the common register unit 114 and write it to the corresponding common register. After receiving the CRF data written by the instruction execution unit 113, the common register unit 114 writes the CRF data into the corresponding common register, and then notifies the dependency flag unit 115 to clean the first destination dependency flag and the second destination dependency flag in the destination state table corresponding to the current written register being written.

The following will illustrate the advantages of some embodiments through a set of examples of instruction execution. Software compilers may be used to mark the dependency relationships between instructions. As shown in the left section of FIG. 7, the R4 (indicated by an underline in the figure) read by the ADD instruction (Ins10) is the R4 (indicated by an underline in the figure) written by the SAMPLE instruction (Ins3). To ensure that the ADD instruction (Ins10) can read R4 correctly, the compiler places a flag (indicated by italics in the figure) on the SAMPLE instruction (Ins3). Before using the SAMPLE instruction (Ins3) result, the compiler generates a CHECK instruction (Ins6) (indicated by italics in the figure). When the wave control unit 112 issues the SAMPLE instruction (Ins3), it sends the flags together. After the SMP unit in instruction execution unit 113 executes the SAMPLE instruction (Ins3), it sends the flags back to the wave control unit 112. When the wave control unit 112 executes the CHECK instruction (Ins6), it checks that the flag returns before issuing subsequent instructions to the instruction execution unit 113.

However, in some embodiments, dependency relationships between instructions may be resolved through hardware, thereby simplifying the complexity of the compiler's work. As shown in the right section of FIG. 7, the ADD instruction (Ins9) will also read the result R4 (indicated by an underline in the figure) of the SAMPLE instruction (Ins3). When the wave control unit 112 executes the SAMPLE instruction (Ins3), it will set the dependency flag dep_flag of R4 to 1. Since Ins4˜Ins8 do not read or write R4, Ins4˜Ins8 can be immediately issued to the instruction execution unit 113 until the wave control unit 112 executes the ADD instruction (Ins9). The wave control unit 112 checks the dependency flag dep_flag of R4 through the dependency flag unit 115, and it is found that at this time, the dependency flag dep_flag is 1, the wave control unit 112 cannot execute the ADD instruction (Ins9). Until the SMP unit finishes executing the SAMPLE instruction (Ins3) and writes the result back to the common register, the common register unit 114 further notifies the dependency flag unit 115 to clean the dependency flag dep_flag of R4. Then, the wave control unit 112 checks that the dependency flag dep_flag of R4 has changed to 0 before issuing the ADD instruction (Ins9) to the instruction execution unit 113.

From the analysis of the above examples, methods may wait for the SAMPLE instruction to finish executing when executing the AND instruction (Ins7 on the left section of FIG. 7). But in some embodiments, it waits for the SAMPLE instruction to finish executing when executing the ADD instruction (Ins9 on the right section of FIG. 7). Thereby the clock cycle of waiting for the SAMPLE instruction to finish executing is reduced. In addition, the CHECK instruction may also be added, which increases the number of instructions of waves and the total execution time of instructions.

According to some embodiments, each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

A person skilled in the art would understand that these modules or units could be implemented by hardware logic such as by logic gates or circuits, firmware, a processor or processors executing computer software code, or a combination thereof. The modules or units may also be implemented in software stored in a memory of a computer or a non-transitory computer-readable medium, where the instructions of each unit are executable by a processor to thereby cause the processor to perform the respective operations of the corresponding module or unit.

The modules or units above may be implemented in processors or central processing units (CPU), a memory, a storage, or at least one network communication interface for receiving input signals or transmitting output signals. The CPU may control operations, and the memory may store computer program instructions. The CPU may include a digital signal processor (DSP), a graphics processing unit (GPU), a neural processing unit (NPU), a microprocessor, a time controller (TCON), a dedicated processor, a micro controller unit (MCU), a micro processing unit (MPU), a controller, an application processor (AP), a communication processor (CP), an ARM processor, or the like. The CPU may be implemented as a System on Chip (SOC) or a large scale integration (LSI) embedded with a processing algorithm, or as a field programmable gate array (FPGA), for example. The modules or units may also be implemented as one or more application specific integrated circuits (ASIC), programmable logic devices, discrete gate devices, or transistor logic devices.

The memory may include registers, such as accumulators (AC), program counters (PC), instruction registers (IR), memory address registers (MAR), memory data registers (MDR), general purpose registers (GPR), stack pointers (SP), base registers (BR), index registers (IR), flag registers (FR) or status registers, segment registers, control registers, debug registers (DR0, DR1, etc.), texture registers, vertex registers, fragment registers, tensor registers, weight registers, activation registers, matrix registers, or accumulator registers, for example, random access memory (RAM) such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synchlink dynamic random access memory (SLDRAM), or direct rambus random access memory (DR RAM), for example.

Some embodiments may include a data storage device such as a hard disk drive (HDD), a solid-state drive (SSD), a magnetic tape, or an optical disc, for example.

Some embodiments provide a computer-readable storage medium, wherein a computer program is stored, which, when running on a computer, causes the computer to execute an execution method for instruction conflict as described in some embodiments.

Some embodiments provide a computer program product, comprising a computer program that, when running on a computer, causes the computer to execute an execution method for instruction conflict as described in some embodiments.

The execution method for instruction conflict, instruction processing module and processor disclosed in some embodiments enable to reduce check instructions when executing multiple instructions of multiple waves, thereby reducing the number of instructions and the total execution time of waves. It can accurately locate the time required to wait for the situation where instruction conflicts occur, without waiting in advance, and directly switch waves for other instruction processing, improving instruction execution efficiency.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An execution method for handling instruction conflict, comprising:
obtaining a plurality of instructions to be executed in a plurality of waves;
determining whether a first instruction of a first wave meets one or more instruction emission conditions;
determining, based on the first instruction meeting the one or more instruction emission conditions, a type of the of the first instruction;
issuing, based on the type being a second type, the first instruction to be executed; and
executing an operation of the first instruction.

2. The execution method according to claim 1, further comprising, based on the first instruction not meeting the one or more instruction emission conditions:
determining whether a second instruction of a second wave meets the one or more instruction emission conditions; and
monitoring the first instruction in real-time until the first instruction meets the one or more instruction emission conditions.

3. The execution method according to claim 2, wherein, the determining whether the second instruction of the second wave meets the one or more instruction emission conditions, and the monitoring the first instruction, are performed simultaneously.

4. The execution method according to claim 2, further comprising, based on the type being a first type:
setting a first source dependency flag corresponding to a source register accessed by the first instruction in a source state table;
setting a first destination dependency flag corresponding to the source register in a destination state table;
setting a second source dependency flag corresponding to a destination register in the source state table; and
setting a second destination dependency flag corresponding to the destination register in the destination state table to a first value.

5. The execution method according to claim 4, further comprising, based on the operation of the first instruction being executed, setting each of the first source dependency flag, the first destination dependency flag, the second source dependency flag, and the second destination dependency flag, to a second value.

6. The execution method according to claim 5, wherein the determining the one or more instruction emission conditions comprises determining whether a plurality of first destination dependency flags corresponding to a plurality of source registers accessed by a first plurality of instructions of the first wave in the destination state table are the second value.

7. The execution method according to claim 6, wherein the determining the type of the first instruction comprises, based on the plurality of first destination dependency flags being the second value, determining whether a plurality of second source dependency flags and a plurality of second destination dependency flags corresponding to the destination register accessed by the first plurality of instructions in the source state table and the destination state table are the second value.

8. The execution method according to claim 6, wherein, based on one or more of the plurality of first destination dependency flags not being the second value,
the determining whether the second instruction of the second wave meets the one or more instruction emission conditions is performed for a second plurality of instructions of the second wave, and
the monitoring the first instruction is performed for the first plurality of instructions.

9. The execution method according to claim 4, wherein the executing the operation of the first instruction comprises:
reading common register data of a common register for the first instruction;
executing the operation of the first instruction and obtaining execution result data; and
writing the execution result data into the common register.

10. The execution method according to claim 9, further comprising:
cleaning the first source dependency flag and the second source dependency flag in the source state table based on the common register data being read; and
cleaning the first destination dependency flag and the second destination dependency flag in the destination state table.

11. A processor for handling instruction conflict, configured to execute processing instructions, the processing instructions comprising:
obtaining instructions configured to cause the processor to obtain a plurality of instructions to be executed in a plurality of waves;
first determining instructions configured to cause the processor to determine whether a first instruction of a first wave meets one or more instruction emission conditions;
second determining instructions configured to cause the processor to determine, based on the first instruction meeting the one or more instruction emission conditions, a type of the of the first instruction;
issuing instructions configured to cause the processor to issue, based on the type being a second type, the first instruction to be executed; and
executing instructions configured to cause the processor to execute an operation of the first instruction.

12. The execution apparatus according to claim 11, wherein the processing instructions further comprise, determining and monitoring instructions configured to cause the processor to, based on the first instruction not meeting the one or more instruction emission conditions:
determine whether the a second instruction of a second wave meets the one or more instruction emission conditions; and
monitor the first instruction in real-time until the first instruction meets the one or more instruction emission conditions.

13. The execution apparatus according to claim 12, wherein the processing instructions further comprise, first setting instructions configured to cause the processor to, based on the type being a first type:
set a first source dependency flag corresponding to a source register accessed by the first instruction in a source state table;
set a first destination dependency flag corresponding to the source register in a destination state table;
set a second source dependency flag corresponding to a destination register in the source state table; and
set a second destination dependency flag corresponding to the destination register in the destination state table to a first value.

14. The execution apparatus according to claim 13, wherein the processing instructions further comprise second setting instructions configured to cause the processor to, based on the operation of the first instruction being executed, set each of the first source dependency flag, the first destination dependency flag, the second source dependency flag, and the second destination dependency flag, to a second value.

15. The execution apparatus according to claim 14, wherein the first determining instructions are configured to cause the processor to determine whether a plurality of first destination dependency flags corresponding to a plurality of source registers accessed by a first plurality of instructions of the first wave in the destination state table are the second value.

16. The execution apparatus according to claim 15, wherein the second determining instructions are configured to cause the processor to, based on the plurality of first destination dependency flags being the second value, determining whether a plurality of second source dependency flags and a plurality of second destination dependency flags corresponding to the destination register accessed by the first plurality of instructions in the source state table and the destination state table are the second value.

17. The execution apparatus according to claim 15, wherein, the determining and monitoring instructions are configured to cause the processor to, based on one or more of the plurality of first destination dependency flags not being the second value:
determine whether the second instruction of the second wave meets the one or more instruction emission conditions is performed for a second plurality of instructions of the second wave, and
monitor whether the first instruction is performed for the first plurality of instructions.

18. The execution apparatus according to claim 13, wherein the executing instructions are configured to cause the processor to:
read common register data of a common register for the first instruction;
execute the operation of the first instruction and obtaining execution result data; and
write the execution result data into the common register.

19. The execution apparatus according to claim 18, wherein the executing instructions are further configured to cause the processor to:
clean the first source dependency flag and the second source dependency flag in the source state table based on the common register data being read; and
clean the first destination dependency flag and the second destination dependency flag in the destination state table.

20. A non-transitory computer-readable storage medium, storing computer code which, when executed by at least one processor, causes the at least one processor to at least:
obtain a plurality of instructions to be executed in a plurality of waves;
determine whether a first instruction of a first wave meets one or more instruction emission conditions;
determine, based on the first instruction meeting the one or more instruction emission conditions, a type of the of the first instruction;
issue, based on the type being a second type, the first instruction to be executed; and
execute an operation of the first instruction.
